(19) United States
(12) Patent Application Publication
(10) Pub. No.: US 2008/0250070 A1
(43) Pub. Date: Oct. 9, 2008

(54) CREATING A REPORT HAVING COMPUTER GENERATED NARRATIVE TEXT

(76) Inventors: Abdulla M. Abdulla, Augusta, GA (US); Philip L. Ames, Augusta, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 12/059,049

(22) Filed: Mar. 31, 2008

Related U.S. Application Data
(60) Provisional application No. 60/908,864, filed on Mar. 29, 2007.

(51) Int. Cl. G06F 7/00

(52) U.S. Cl. 707/104.1

(57) ABSTRACT

The present invention provides a system that creates a report that includes complete sentences based on input values that reflect measured or observed patient conditions. The system creates a sentence or a portion of a sentence that describes the patient's condition by comparing the input values for one or more attributes to the default values for those attributes. The default values are pre-determined and are usually based on medical standards. By comparing the input values to the default values the system can generate highly descriptive text that describes the patient's condition in a narrative form.

### RELATED APPLICATIONS

This application claims priority to U.S. Provisional Application No. 60/908,864 entitled “Electronic Health Record and Automated Clinical Reporting System” filed Mar. 29, 2007, which is incorporated herein by reference.

### TECHNICAL FIELD

The present invention is directed in general to creating a report using computer generated text, and in particular to generating a report by comparing input values to default values to create narrative text.

### BACKGROUND

Healthcare providers spend a great deal of time creating medical reports to document the diagnoses, care and treatment of patients. Various options are available to create such reports, including manual creation, dictation, or template systems. In a template system a user inputs data and then the system inserts the data into a pre-existing template to create a report. A report produced by a template system generally includes rigid, disjointed text that is obviously computer-generated. When using a template system care must be taken to select the correct template given the clinical diagnosis and the patient information. Otherwise the template will guide the healthcare provider's conclusions, rather than having the patient's information and data guide the conclusions.

Since a template is not flexible, a large number of templates are required to address all the possible problems or issues that may arise. The number of templates may make it difficult for a user to select the correct template. A user may discover that the wrong template was selected after much of it has been completed. If so, then the user is required to start over with the correct template. Accordingly a needs exists for a system to support the creation of reports that is more flexible than a template system and that generates narrative text.

### SUMMARY OF THE INVENTION

The present invention provides a system that creates a report that includes complete sentences based on input values entered by a user or received from medical diagnostic equipment. An input value usually corresponds to measured or observed condition of a patient and is associated with an attribute. An attribute that describes a measured condition is usually associated with a numeric value, whereas an attribute that describes an observed condition is usually associated with a text value. The system may also include other types of attributes, such as an attribute that corresponds to patient demographic information.

The system creates a sentence or a portion of a sentence that describes the patient's condition by comparing the input values for one or more attributes to the default values or other predefined values for those attributes. The default values are pre-determined and are usually based on medical standards. By comparing the input values to the default values the system can generate highly descriptive text that describes the patient's condition in a narrative form.

These and other aspects, features and advantages of the present invention may be more clearly understood and appreciated from a review of the following detailed description of the disclosed embodiments and by reference to the appended drawings and claims.

### BRIEF DESCRIPTION OF THE DRAWINGS

FIGS. 1A-1J are screen shots illustrating a user interface in accordance with an embodiment of the invention.

FIG. 2 is a flow diagram of a method for creating text in accordance with an embodiment of the invention.

FIGS. 3A and 3B are screen shots for selected a user interface in accordance with an embodiment of the invention.

FIG. 4 is a table illustrating the restriction of input values for an attribute that is associated with a text value in accordance with an embodiment of the invention.

FIG. 5 is a table illustrating the determination of a text phrase based on attribute values in accordance with an embodiment of the invention.

FIG. 6 illustrates an exemplary implementation of the determination of a text phrase based on attribute values.

### DETAILED DESCRIPTION

The present invention is directed towards a system and method for creating a report, such as a medical report, by using a computer to generate text based on comparisons of input values to default values. The input values may correspond to a measured condition of a patient or an observed condition of a patient. The default values correspond to medical standards. Based on the comparisons, text phrases are selected which describe the patient's condition. The text phrases are combined with other text, such as text prefixes and/or text suffixes to create complete sentences and the sentences are organized into a report.

### Exemplary User Interface

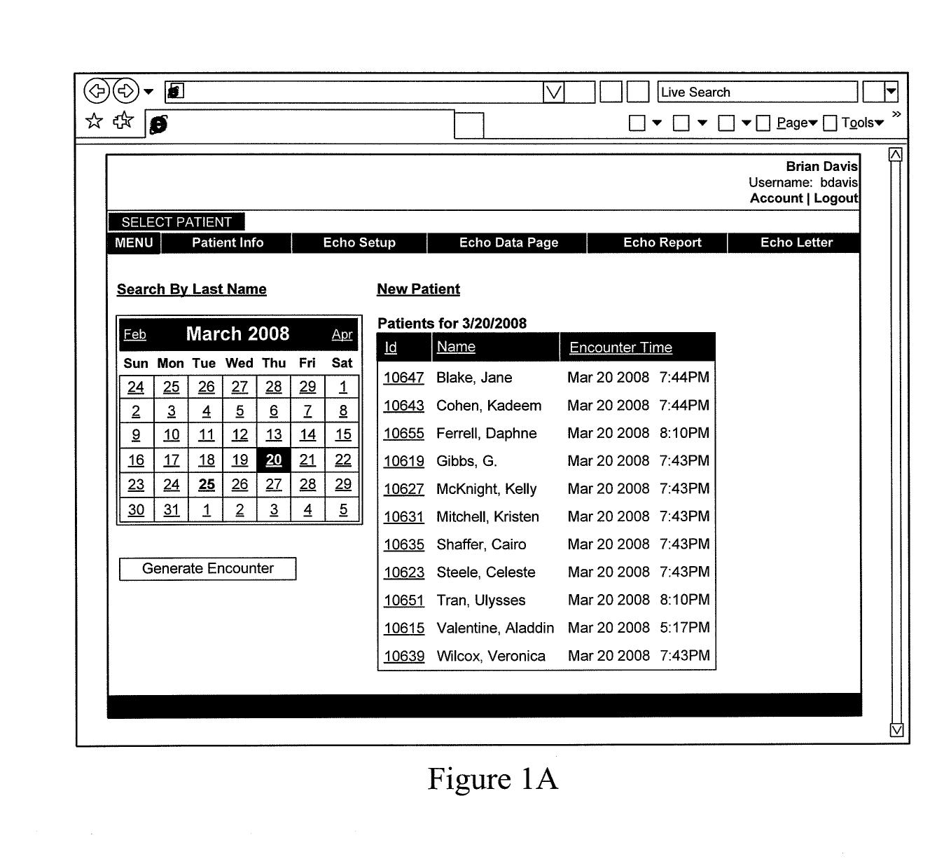

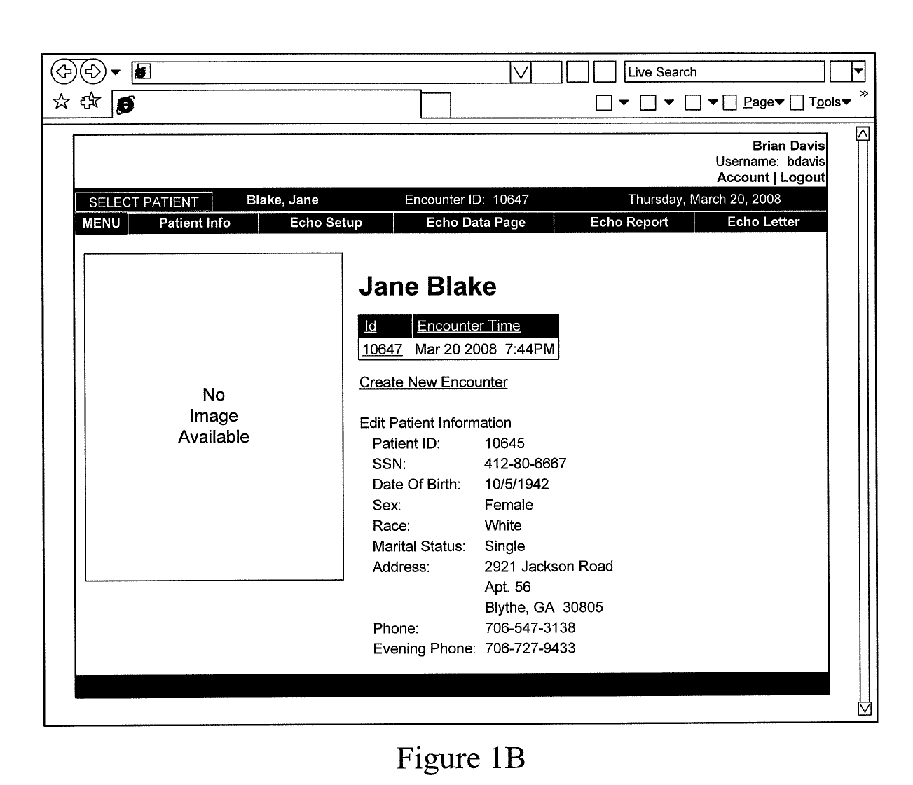

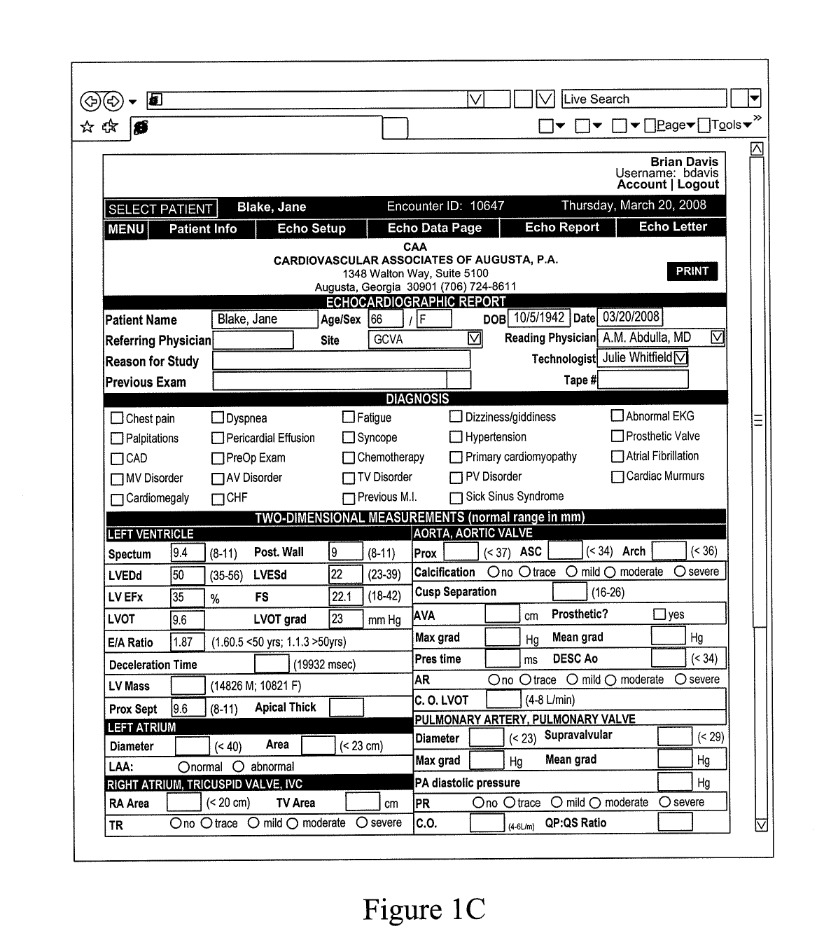

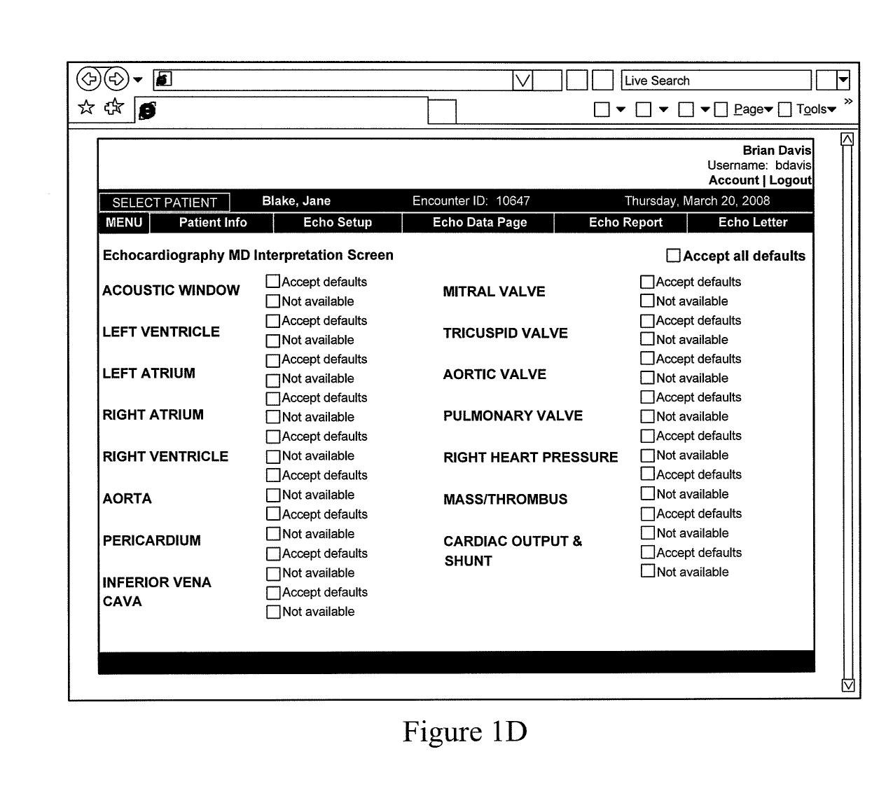

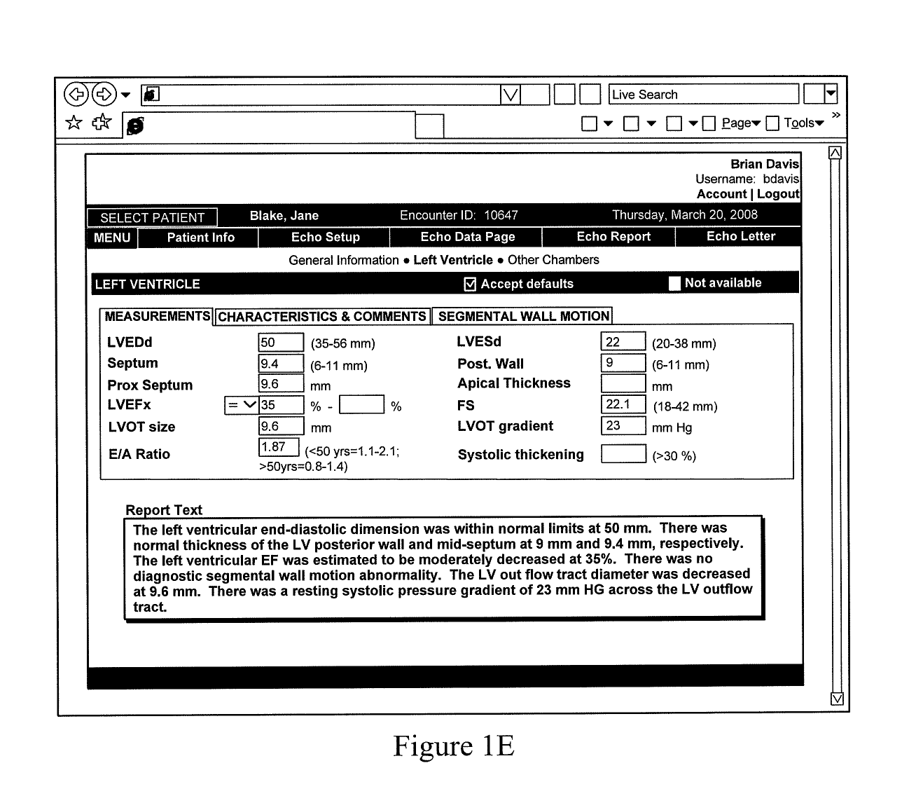

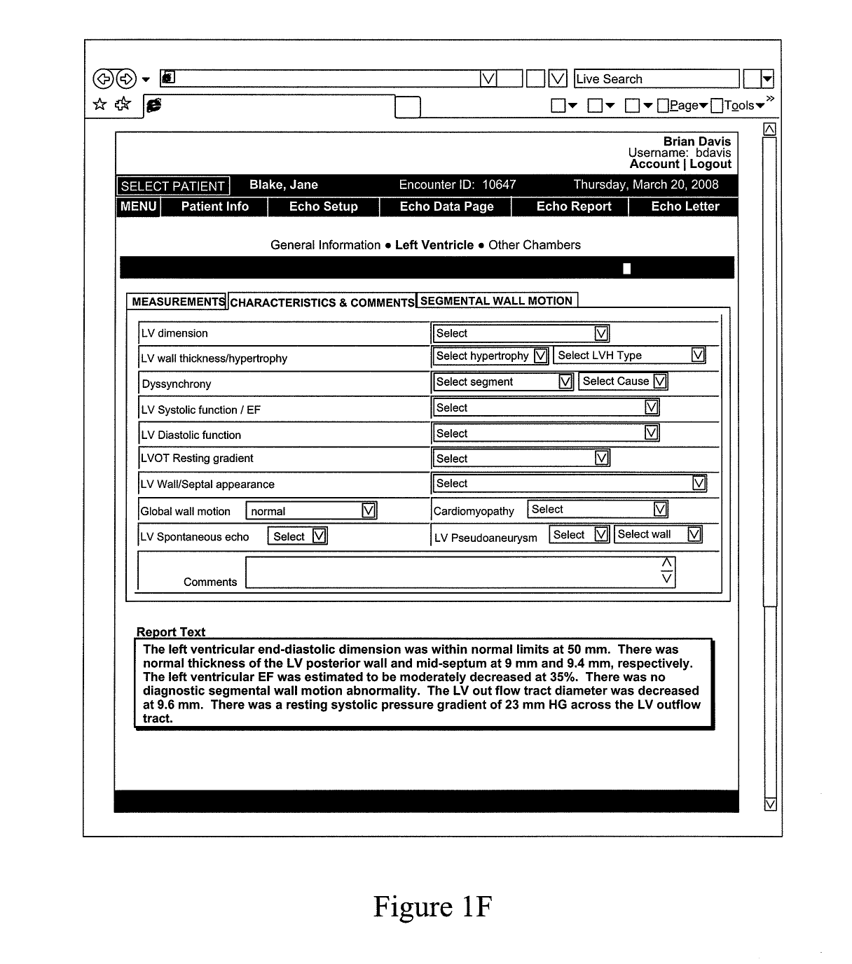

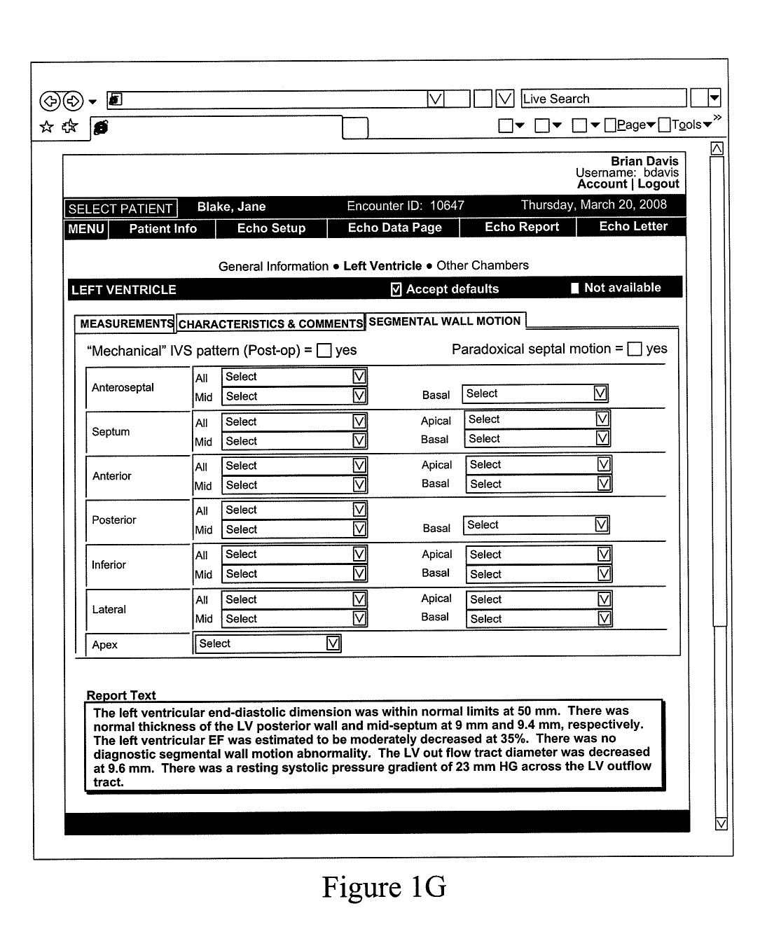

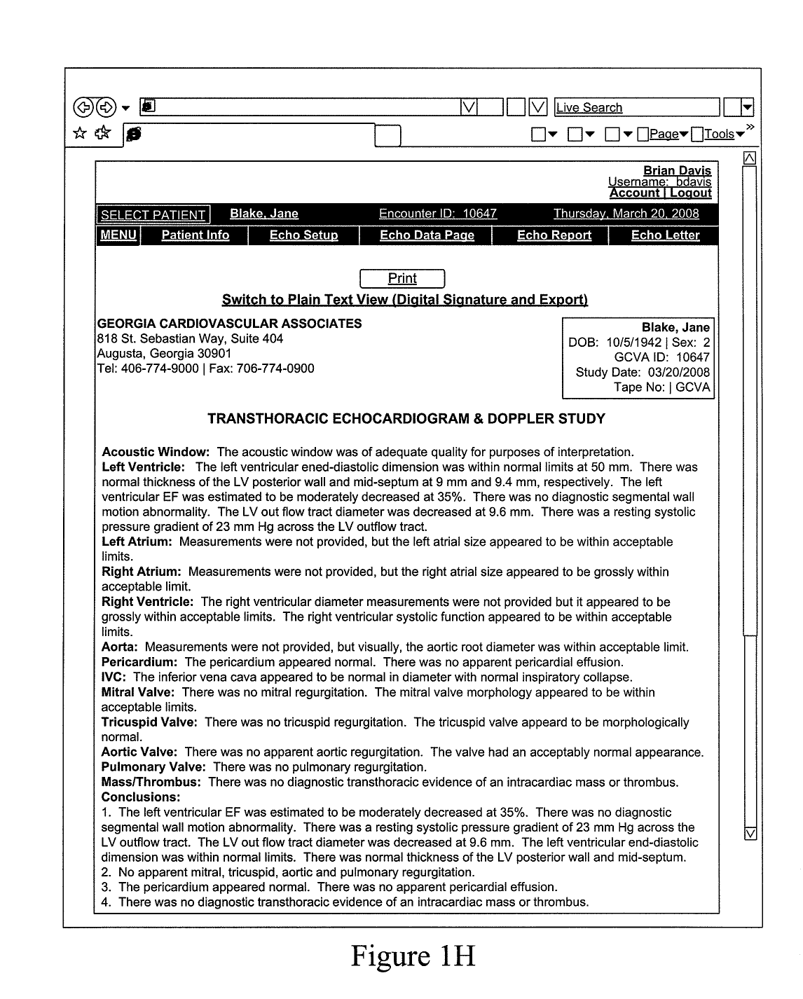

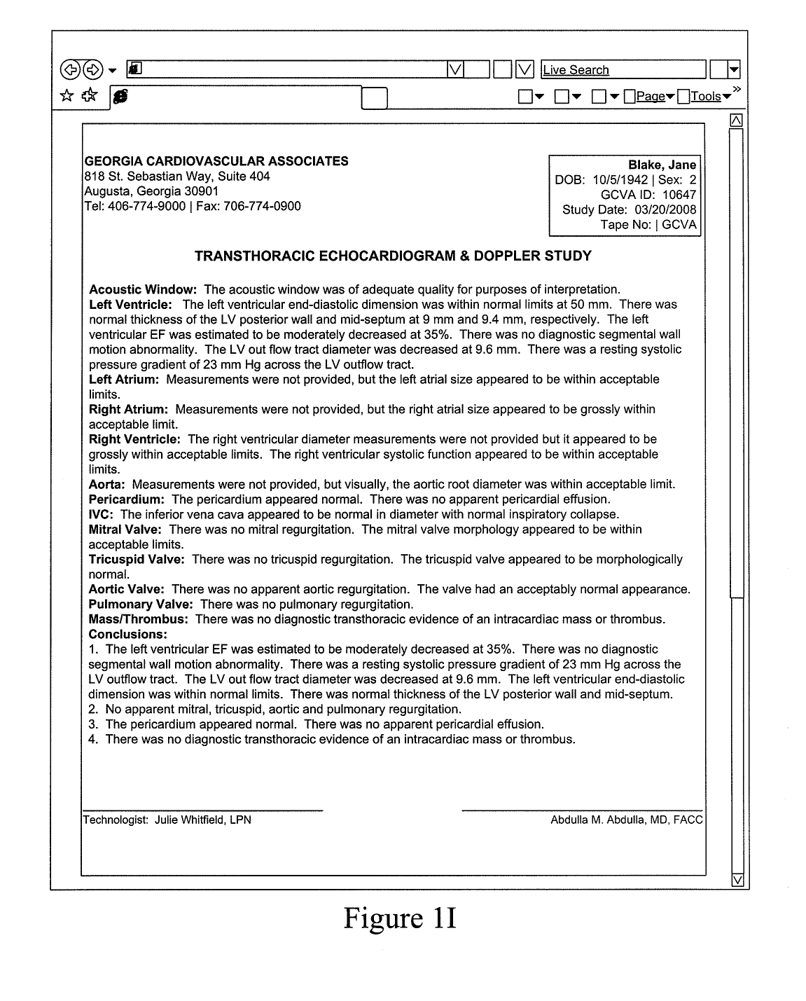

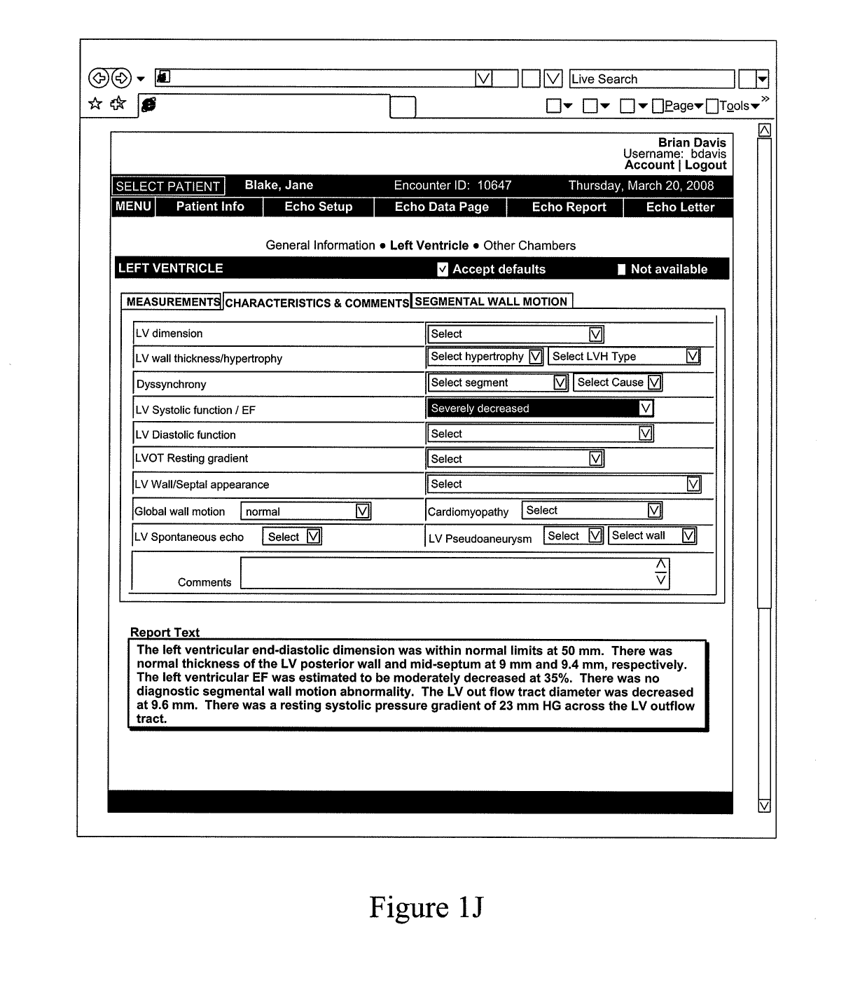

FIGS. 1A through 1J illustrate an exemplary user interface for guiding a user through the steps of creating a medical report. All patient information shown in FIGS. 1A through 1J is fictitious. FIG. 1A illustrates a patient selection interface which allows a user to select a patient by name (e.g. by selecting the Search by Last Name option) or by date of visit (e.g. by selecting a date on the calendar) or to enter information for a new patient (e.g. by selecting the New Patient option). Once a patient is selected, the patient information interface shown in FIG. 1B is displayed, which allows a user to update patient information or generate a report, such as an echocardiogram report.

If the user selects the Echo Data Page option, then FIG. 1C is presented to the user. FIG. 1C provides an overview of the information and data that will be used to generate an echocardiogram report for the patient. FIG. 1C includes left ventricle measurements, such as mid-septum wall thickness (Septum) measured at 9.4 mm and left ventricular end-diastolic dimension (LVEDd) measured at 50 mm. The measurements can be entered by a medical technologist via the Echo Data Page or can be imported from the medical equipment that took the measurements.

If the user selects the Echo Setup option, then FIG. 1D is presented to the user. FIG. 1D allows the user to accept default values. A default value is a value that is predetermined and is generally based on medical standards, such as the standards set by the American Society of Echocardiography for an echocardiogram report. The measurements for a selected patient are compared to the default values or ranges of default values to create the report. FIG. 1D illustrates that a user can accept or decline defaults for each subsection of the report.

FIG. 1E provides additional details regarding the creation of the text for the left ventricle subsection of the report. FIG. 1E shows the measurement data (also referred to herein as the input values) for a number of different attributes. The default values are shown in parenthesis next to each input value. For example, the input value for left ventricular end-diastolic dimension (LVEDd) attribute is 50 mm and the range of default values is 35-56 mm. The system uses a series of comparisons or conditional statements which compare the input value with the default values and possibly patient demographic information, such as the patient's sex, to create the following sentence, which is shown in the Report Text section:
The left ventricular end-diastolic dimension was within normal limits at 50 mm.
   The sentence generated by the system provides a richer description of the patient's condition than that generated by a system that uses a template. In the foregoing example the LVEDd dimension is 50 mm, which is within the default range of 35-56 mm. The text states that the “left ventricular end-diastolic dimension was within normal limits at 50”, rather than just stating the measured left ventricular end-diastolic dimension. Additional details describing how the text is created are provided in Section entitled “Exemplary Text Creation.” The other sentences in the report text shown FIG. 1E are created in a similar manner.

In addition to physical measurements, the system also handles user observations of the patient's condition. FIGS. 1F and 1G illustrate a series of drop down menus which allows a user to enter observations for certain left ventricle characteristics or attributes. Some of the characteristics are related to the measurements, but others are independent. For example, the LV Systolic function/EF attribute shown in FIG. 1F is related to the left ventricular end-diastolic dimension attribute in FIG. 1E, whereas the Dyssynchrony attribute is independent of the left ventricle measurement attributes. The report includes a sentence or a portion of a sentence that reflects each observation.

Based upon the input values, the observations, the default values and the patient information, the system creates a report, as illustrated in FIG. 1H. The illustrated report includes complete sentences that include text appropriate for the specific patient. In some embodiments, the report includes a conclusion subsection. The conclusion subsection includes sentences that highlight the most important measurements or observations. If the user is satisfied with the report, then the user can proceed to sign the report using the screen illustrated in FIG. 1I. Once the report is completed the report can be stored as an electronic health record, printed, and/or sent to another system for further processing.

If the user wants to modify the report, then the user can select a subsection to modify. For example, if the user wants to modify the sentence “The left ventricular EF was estimated to be moderately decreased at 35%”, then the user selects the Left Ventricle subsection either directly from the report or via the Menu option. By changing the input value in the drop down menu that corresponds to LV Systolic function/EF, the user can replace “moderately decreased” with “severely decreased” as shown in FIG. 1J and the system dynamically updates the report text without requiring the user to update or reload the page.

### Exemplary Method for Creating a Report

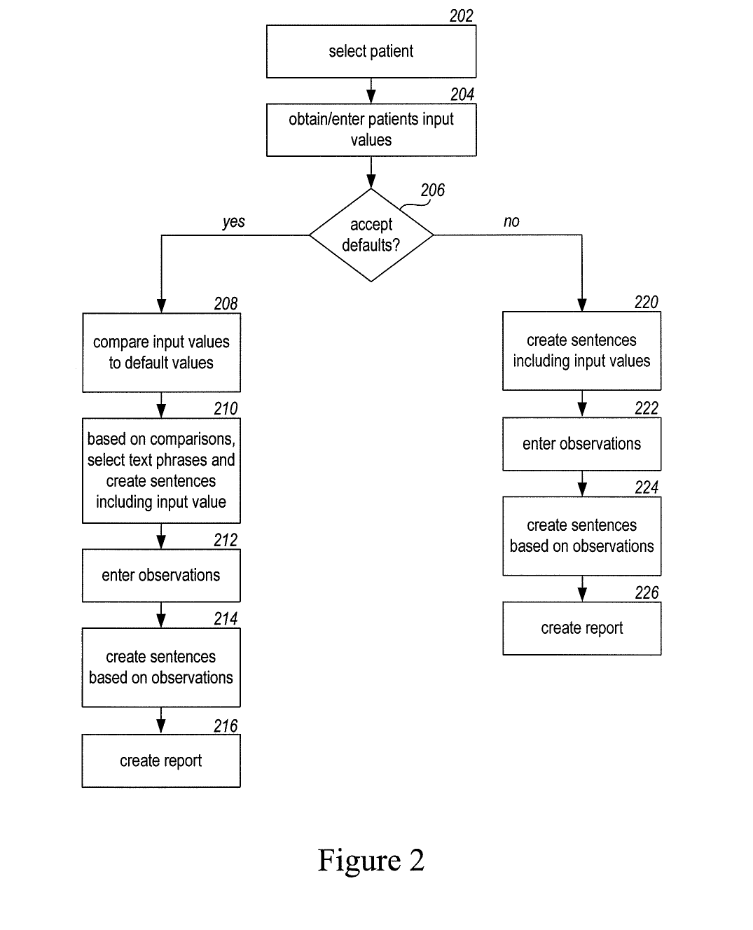

FIG. 2 illustrates an exemplary method for creating a medical report. In step 202 a user selects a patient and the system obtains relevant patient information, such as age, sex, etc. Once a patient is selected, then in step 204 the input values are obtained from the medical equipment that performed the measurements or are entered by the user. In step 206, the user determines whether to accept the default values. If the report includes multiple subsections, then it may be possible to accept or decline defaults on a subsection by subsection basis.

If the defaults are accepted, then the method proceeds to step 208. In step 208 an input value received in step 204 is compared to the default value or range of default values. In some instances, patient demographic information is used in the comparison. For example, some comparisons consider the sex of the patient. Based on the outcome of the comparison made in step 208, a text phrase is selected in step 210. The text phrase is used to create a sentence, which may include the input value.

In step 212 the user enters observations about the patient's condition. Typically, the observations are entered via a drop down menu. Although using a drop down menu restricts the content of the observations, it also ensures continuity across reports and allows the data in the report to be used by other systems. Once the user enters an observation, the system generates a sentence or a portion of a sentence based on the observation in step 214.

Although not shown in FIG. 2, steps 208 through 214 can be repeated for each subsection of the report or for multiple attributes within a subsection of a report. If a report subsection does not include any observations, then steps 212 and 214 are skipped. Similarly, if a report subsection does not include any measurements, then steps 208 and 210 are skipped. In step 216 a report is created which includes the sentences created in steps 210 and 214.

If the user declines the defaults, then the method proceeds from step 206 to step 220. In step 220 the system generates sentences or portions of sentences using the input values received in step 204. Since the defaults were not accepted, the input values are not compared to the defaults. Instead the system generates sentences that include the input values, but are not as descriptive as those generated in step 210. For example, if defaults are not accepted and the left ventricular end-diastolic dimension is 50 mm, then the system generates a sentence stating that “The left ventricular end-diastolic dimension was 50 mm”. This sentence does not include descriptive text such as “within normal limits” or “mildly dilated” which appears when the defaults are accepted.

In step 222 the user enters observations about the patient's condition, similar to that described above in connection with step 212. Once the user enters an observation, the system generates a sentence or a portion of a sentence based on the observation in step 224. Although not shown in FIG. 2, steps 220 through 224 can be repeated for each subsection of the report or for multiple attributes within a subsection. If a report subsection does not include any observations, then steps 222 and 224 are skipped. Similarly, if a report subsection does not include any measurements, then step 220 is skipped. In step 226 a report is created which includes the sentences created in steps 220 and 224.

If the user accepts defaults for some, but not all, subsections of the report, then steps 208-214 are executed for those subsections where the defaults were accepted and steps 220-224 are executed for those subsections where the defaults were declined and the report includes the sentences for all of the subsections.

There may be different users associated with different steps. If a medical technologist enters patient data, then the medical technologist is associated with steps 202 and 204. If the medical technologist also enters some observations, then the medical technologist is also associated with step 212 or 222. Typically a physician, such as a cardiologist, is associated with the steps related to accepting defaults and entering observations, as well as any steps to override text generated by the system.

### Exemplary Text Creation

The system uses attributes, input values and conditional statements to create the sentences of the report. An attribute represents a single item of interest and can be assigned a value, such as text, a numeric value, or another type of value. An attribute can correspond to a patient measurement or to a patient observation.

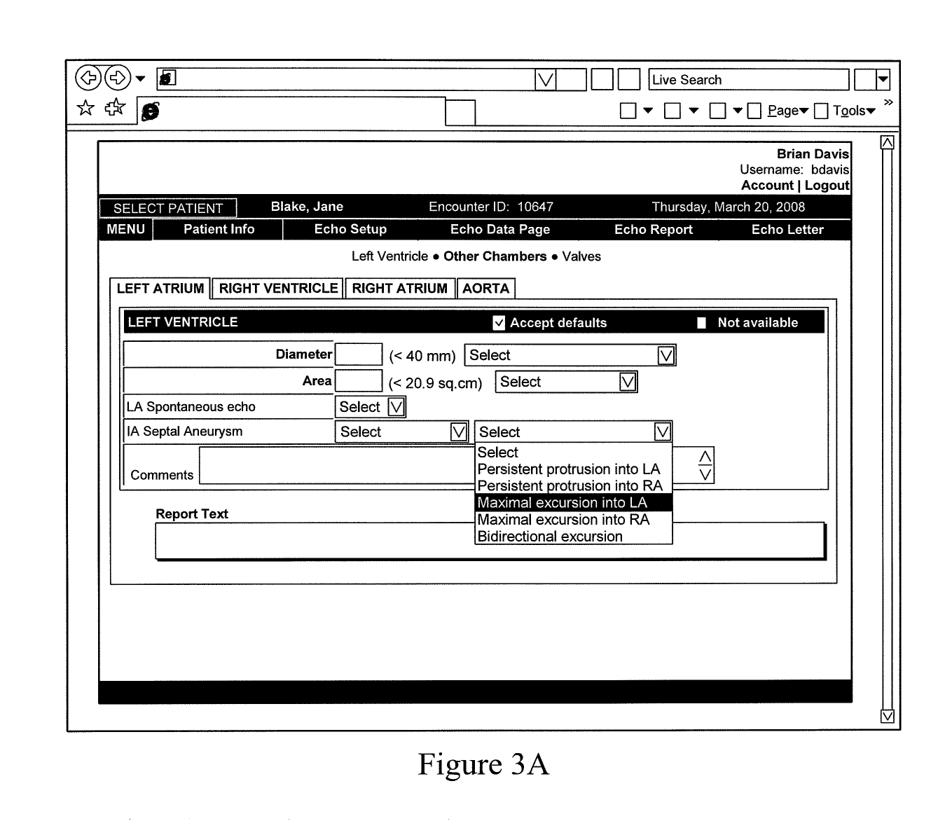

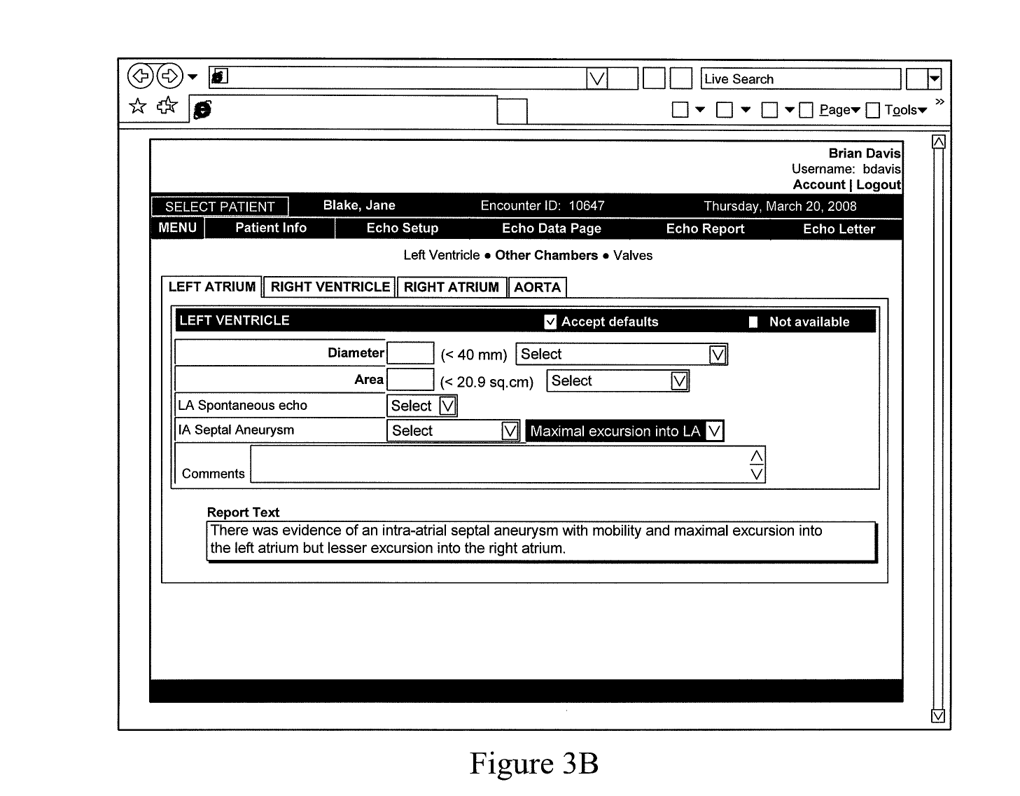

An example of an attribute which can be assigned a text value is intra-atrial septal aneurysm (elASaneurysm) attribute. FIG. 3A illustrates a drop down menu which presents options to the user for the elASaneurysm attribute. Attributes that can be assigned a text value may be restricted to a specific set of values by associating the attribute with an attribute list. Restricting the text values provides more uniform reports and allows the reports to be exported to other systems for additional processing.

The elASaneurysm attribute is restricted to five values: (1) persistent protrusion into LA, (2) persistent protrusion into RA, (3) maximal excursion into LA, (4) maximal excursion into RA, and (5) bidirectional excursion, as shown in the drop down menu of FIG. 3A. If the user selects the maximal excursion into LA option, then the sentence shown in FIG. 3B is generated to describe the intra-atrial septal aneurysm.

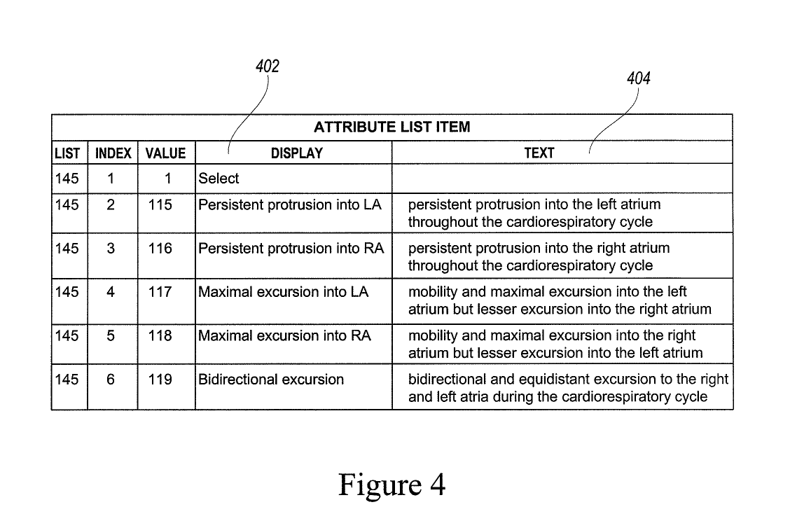

FIG. 4 shows an attribute list for the elASaneurysm attribute. The attribute list includes a column, the Display column 402, that includes the options provided to a user and a column, the Text column 404, for the corresponding text phrase that is used to create a sentence for the report. Often times the text in the Display column is an abbreviation or shorthand version of the complete word or phase shown in the corresponding Text column. With reference to FIG. 4, if the user selects “Maximal excursion into LA” from a drop down menu, then the system creates a sentence that includes the text phrase “mobility and maximal excursion into the right atrium but lesser excursion into the left atrium.”

The attribute list also associates a numeric value with each text value. For example, the numeric value of 115 corresponds to the display value of “persistent protrusion into LA” and the text value of “persistent protrusion into the left atrium throughout the cardiorespiratory cycle” and the numeric value of 116 corresponds to the display value of “persistent protrusion into RA” and the text value of persistent protrusion into the right atrium throughout the cardiorespiratory cycle.”

An example of an attribute which can be assigned a numeric value is the left ventricular end-diastolic dimension (LVEDd) attribute. See FIG. 1E which shows that the numeric value or input value that corresponds to the LVEDd attribute is 50 mm. Many of the attributes that can be assigned a numeric value correspond to patient measurements.

In addition to the attributes that correspond to text or to numeric values, there are also attributes that indicate whether a user has overridden text generated by the system or whether the user has accepted the default values, as well as attributes that correspond to patient demographic information, such as an attribute corresponding to the patient's sex. Attributes that correspond to check boxes, such as a check box to accept defaults or a check box to indicate that a condition is absent, typically corresponds to a Boolean value. For example, the accept defaults attribute is assigned one value if defaults are accepted and a second value if defaults are declined.

To generate a sentence or a portion of a sentence that describes the patient's condition, the system considers the input values that correspond to a predetermined set of attributes. The system compares the input values for the set of attributes to the default values to generate a sentence or a portion of a sentence.

To generate a sentence that describes the left ventricular end-diastolic dimension, the system considers four attributes. The first attribute corresponds to a user override, the second attribute corresponds to acceptance of defaults, the third attribute corresponds to the left ventricular end-diastolic dimension, and the fourth attribute corresponds to the patient's sex. If the input value for the first attribute indicates that the user has not entered an override and if the input value for the second attribute indicates that the user has accepted the defaults, then the input values corresponding to the left ventricular end-diastolic dimension and the patient's sex determine the text.

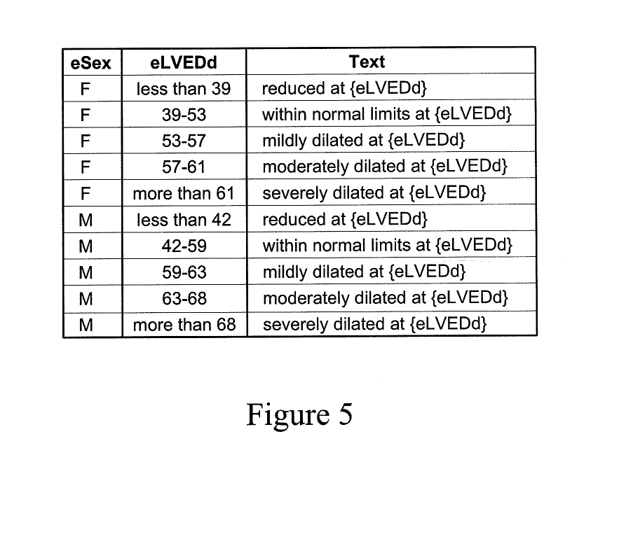

FIG. 5 illustrates how the attributes for the left ventricular end-diastolic dimension and the patient's sex determine the text. In this example, the patient's sex is an attribute that is associated with an attribute list that includes values for male, female and unknown. If the patient is a male (input value for eSex corresponds to M) and the LV end-diastolic dimension (eLVEDd) is 61.2 mm, then the system generates the text phrase of “mildly dilated at 61.2 mm.” If the patient is a female (input value for eSex corresponds to F) with an LV end-diastolic dimension of 61.2 mm, then the system generates the text phrase of “severely dilated at 61.2 mm.” The text phrase generated by the system can be combined with a text prefix and/or text suffix to generate a complete sentence. For example, adding a text prefix of “The left ventricular end-diastolic dimension was” to the text phrases of these examples results in “The left ventricular end-diastolic dimension was mildly dilated at 61.2 mm” and “The left ventricular end-diastolic dimension was severely dilated at 61.2 mm.”

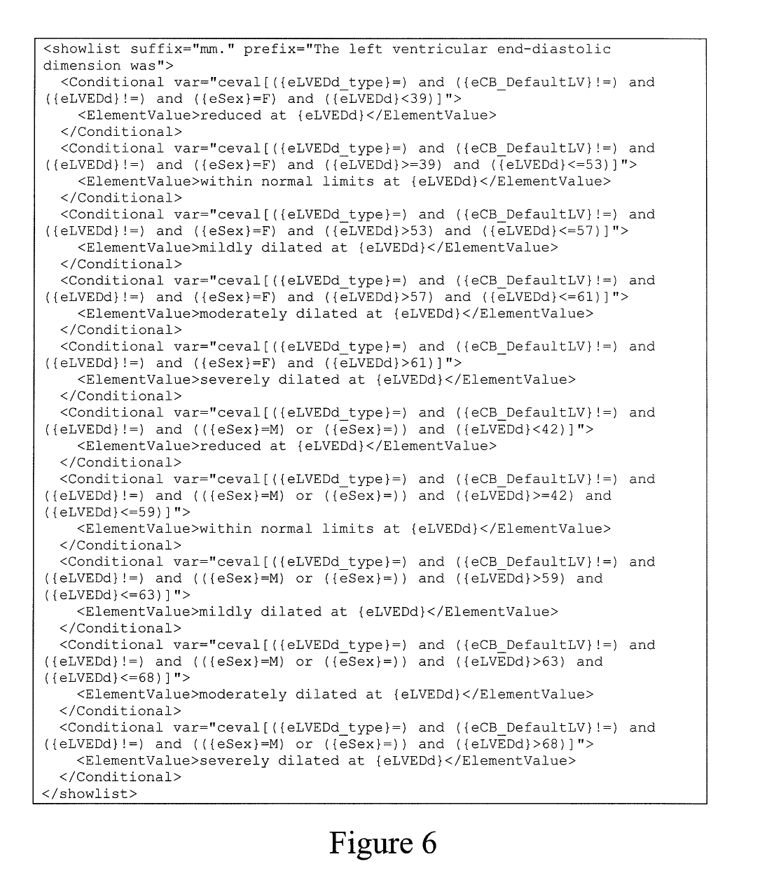

FIG. 6 illustrates an exemplary implementation of the conditional statements used for generating text associated with the left ventricular end-diastolic dimension (LVEDd). Although FIG. 6 illustrates a series of conditional statements in a show list concept, other implementations are possible. The user override attribute corresponds to eLVEDd type, the default attribute corresponds to eCB_defaultLV, the left ventricular end-diastolic dimension attribute corresponds to eLVEDd, and the patient's sex attribute corresponds to eSex.

### Exemplary Operating Environment

In one embodiment the system is implemented as an internet application and the user accesses the system using an internet browser. In this embodiment, the system operates on one or more centrally located servers, patient information and input values for the attributes are stored in one or more centrally located databases, and the user accesses the system using a client system. The report generated by the system can be displayed to the user via a display device associated with the client system, printed on a printer accessible to the client system, or communicated to another system or device. If the measurement data is obtained directly from the equipment, then a locally resident module interfaces with the equipment to collect the data and then uploads the data to the database. In one embodiment, the system uses Asynchronous JavaScript and XML (AJAX) protocol to store and retrieve discrete data from the database, which allows dynamic updating of the report. In some embodiments, instructions for implementing the system are stored as computer executable instructions on a computer-readable storage medium, such as a memory device or disk. Other types of computing environments and implementations are also possible, including both distributed and stand alone systems.

In addition to being displayed, the report can be stored in a file on the server while the input values used to create the report can be stored in the database. The user also can export the report to a file that can be saved elsewhere and/or sent to another system.

In one embodiment, the system is created using a content development system that supports a name-value pair methodology through which the logic can be extended or modified without changing the structure of the database tables. This type of content development system provides maximum flexibility in making changes or additions to the logic. The content development tool creates various types of phrases, such as processing logic phrases (e.g. conditional statement for comparing an input value to a default value), user input phrases (e.g. data entry via check boxes and drop down menus), element layout phrases (e.g. report format) and information display phrases.

Although the foregoing examples describe the generation of reports for a cardiology practice, the invention can be used to create other types of reports. Any type of medical report can be generated and the report can cover multiple encounters or physiological systems.

Additional alternative embodiments will be apparent to those skilled in the art to which the present invention pertains without departing from its spirit and scope. Accordingly, the scope of the present invention is described by the appended claims and is supported by the foregoing description.

What is claimed is:

1. A method for creating a medical report using computer generated text, comprising:
receiving an identification of a patient;
receiving input values for a plurality of report attributes;
receiving a default selection, wherein the default selection specifies a default value or a default range that corresponds to each of the report attributes;
for each of the report attributes:
comparing the input value corresponding to the report attribute to the default value or default range corresponding to the report attribute; and
based on the comparison, selecting a text phrase;
combining the text phrase with a text prefix to create a sentence, wherein the text prefix corresponds to the report attribute;
creating the medical report that includes the sentences corresponding to the report attributes; and
providing the medical report to the user.

2. The method of claim 1, wherein combining the text phrase with a text prefix to create a sentence further comprises inserting the input value into the text phrase.

3. The method of claim 1, wherein combining the text phrase with a text prefix to create a sentence further comprises combining the text phrase with a text suffix, wherein the text suffix corresponds to the report attribute.

4. The method of claim 1, wherein receiving input values for a plurality of report attributes, comprises:
for a selected report attribute:
providing a plurality of options for the selected report attribute;
receiving a selection of one of the options;
based on the selected option, selecting a numeric value that corresponds to the selected option.

5. The method of claim 1, wherein receiving input values for a plurality of report attributes, comprises:
for a selected report attribute, receiving data transferred from medical diagnostic equipment.

6. The method of claim 1, further comprising:
receiving override text corresponding to a selected sentence; and
modifying the selected sentence so that the override text replaces a portion of the sentence.

7. The method of claim 1, wherein a selected report attribute corresponds to a measured condition of the patient.

8. The method of claim 1, wherein a selected report attribute corresponds to a an observed condition of the patient.

9. The method of claim 1, wherein comparing the input value corresponding to the report attribute to the default value or default range corresponding to the report attribute, further comprises using patient demographic information in the comparison.

10. A method for creating a medical report using computer generated text, comprising:
receiving a first input value for a first report attribute, wherein the first input value is a numeric value and the first report attribute is related to a measured condition of a patient;
receiving a default selection, wherein the default selection specifies a default value or a default range that corresponds to the first report attribute;
comparing the first input value to the default value or default range corresponding to the first report attribute;
based on the comparison, selecting a text phrase;
generating a sentence that includes the text phrase and the first input value;
displaying the sentence to a user;
receiving override text corresponding to the first sentence;
modifying the sentence so that the override text replaces a portion of the sentence;
creating the medical report that includes the modified sentence; and
providing the medical report to the user.

11. The method of claim 10, further comprising:
receiving a second input value for a second report attribute, wherein the second input value is a text value and the second report attribute is related to an observed condition of the patient;
based on the second input value, selecting a second text phrase;
generating a second sentence that includes the second text phrase; and
displaying the second sentence to the user.

12. The method of claim 10, wherein generating a sentence that includes the text phrase and the first input value further comprises including a text prefix that corresponds to the first report attribute before the text phrase.

13. The method of claim 10, wherein generating a sentence that includes the text phrase and the first input value further comprises including a text suffix that corresponds to the first report attribute after the text phrase.

14. The method of claim 10, wherein comparing the first input value to the default value or default range corresponding to the first report attribute further comprises using patient demographic information in the comparison.

15. A computer-readable medium having computer executable instructions for a method for creating a medical report using computer generated text, comprising:
receiving a first input value for a first report attribute, wherein the first input value is a numeric value and the first report attribute is related to a measured condition of a patient;
receiving a default selection, wherein the default selection specifies at least one default value that corresponds to the first report attribute;
comparing the first input value to the default value corresponding to the first report attribute;
based on the comparison, selecting a text phrase;
generating a sentence that includes the text phrase and the first input value;
displaying the sentence to a user;
receiving a second input value for a second report attribute, wherein the second input value is a text value and the second report attribute is related to an observed condition of the patient;
based on the second input value, selecting a second text phrase;
generating a second sentence that includes the second text phrase;
displaying the second sentence to the user;
creating the medical report that includes the first sentence and the second sentence; and
providing the medical report to the user.

16. The computer-readable medium of claim 15, further comprising:
receiving override text corresponding to the sentence;
modifying the sentence so that the override text replaces a portion of the sentence; and
displaying the modified sentence to the user.

17. The computer-readable medium of claim 15, wherein generating a sentence that includes the text phrase and the first input value further comprises including a text prefix that corresponds to the first report attribute before the text phrase.

18. The computer-readable medium of claim 15, wherein generating a sentence that includes the text phrase and the first input value further comprises including a text suffix that corresponds to the first report attribute after the text phrase.

19. The computer-readable medium of claim 15, wherein comparing the first input value to the default value corresponding to the first report attribute further comprises using patient demographic information in the comparison.
